(19) United States
(12) Patent Application Publication
(10) Pub. No.: US 2009/0154586 A1
(43) Pub. Date: Jun. 18, 2009

(54) MIMO RECEIVER, QR DECOMPOSITION AND MULTI-DIMENSIONAL DETECTION USED IN THE MIMO RECEIVER

(75) Inventors: Yu-Ro Lee, Daejon (KR); Jong-Ee Oh, Daejon (KR); Minho Cheong, Daejon (KR); Sok-Kyu Lee, Daejon (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/177,418

(22) Filed: Jul. 22, 2008

(30) Foreign Application Priority Data
Dec. 17, 2007 (KR) 10-2007-0132492

(51) Int. Cl. H04L 1/02; H04L 27/06

(52) U.S. Cl. 375/267; 375/340

(57) ABSTRACT

Provided are a receiver of a Multiple Input Multiple Output (MIMO) system, QR decomposition and multi-dimensional detection used in the receiver. The receiver includes: a QR decomposing unit for performing a QR decomposing operation in cycles 1 to n_{T}-n−1, and performing a column exchanging operation in cycles n_{T}-n to n_{T} as QR decomposition where n and T are an integer number; and a multi-dimensional detecting unit for receiving a first R matrix R_{y} and a second R matrix R_{z} from the QR decomposing unit, calculating a first distance value for detecting an m^{th} symbol for the first R matrix and a second distance value for detecting an m^{th} symbol for the second R matrix, and simultaneously detecting an m^{th} symbol and an (m−1)^{th} symbol using the first distance value and the second distance value.

### TECHNICAL FIELD

The present invention relates to a receiver of a Multiple Input Multiple Output (MIMO) system, QR decomposition apparatus and method used in the receiver, and a multi-dimensional detection apparatus and method used in the receiver; and, more particularly, to an MIMO receiver for reducing delay in a multi-dimensional receiving process by repeatedly processing predetermined columns and simultaneously processing symbol detection in parallel when QR decomposition is performed in a receiver of Orthogonal Frequency Division Multiplexing (OFDM) MIMO system, a QR decomposition apparatus and method used in the receiver, and multi-dimensional detection apparatus and method used in the receiver.

This work was supported by the IT R&D program of MIC/IITA [2006-S-002-02, “IMT-Advanced Radio Transmission Technology with Low Mobility”].

### BACKGROUND ART

Wireless communication systems are required to be capable of transmitting a large amount of high-quality multimedia data using limited frequency. As a method for transmitting a large amount of data using a limited frequency, a Multiple Input Multiple Output (MIMO) system was introduced. The MIMO system forms a plurality of independent fading channels using multiple antennas at receiving and transmitting ends and transmits different signals through each of multiple transmission antennas, thereby significantly increasing a data transmission rate. Accordingly, the MIMO system can transmit a great deal of data without expansion of a frequency.

However, the MIMO system has a shortcoming that the MIMO system is weak to inter-symbol interference (ISI) and frequency selective fading. In order to overcome the shortcoming, an orthogonal frequency division multiplexing (OFDM) scheme was used. The OFDM scheme is the most proper modulation scheme for transmitting data at a high speed. The OFDM scheme transmits one data row through a subcarrier having a low data transmission rate.

A channel environment for wireless communication has multiple paths due to obstacles such as a building. In a wireless channel environment having multi-paths, delay spread occurs due to the multiple paths. If delay spray time is longer than a symbol transmission interval, inter-symbol interference (ISI) is caused. In this case, frequency selective fading occurs in a frequency domain. In case of using a single carrier, an equalizer is used to remove the ISI. However, complexity of the equalizer increases as a data transmission rate increases.

The shortcomings of the MIMO system can be attenuated using an orthogonal frequency division multiplexing (OFDM) technology. In order to overcome the shortcomings of the MIMO system while maintain the advantages of the MIMO system, an OFDM technology was applied to an MIMO system having N transmission antennas and N reception antennas. That is, an MIMO-OFDM system was introduced.

FIGS. 1A and 1B are block diagrams schematically illustrating an MIMO OFDM system. FIG. 1A is a block diagram of a transmitting end in the MIMO-OFDM system, and FIG. 1B is a block diagram of a receiving end in the MIMO-OFDM system.

Referring to FIG. 1A, the transmitting side includes a serial-to-parallel (S/P) converter 101, a plurality of encoders 102, a plurality of quadrature amplitude modulation (QAM) mappers 103, a plurality of inverse fast Fourier transformers (IFFT) 104, a plurality of cyclic prefix (CP) inserters 105, and digital-to-analog conversion (DAC) radio frequency (RF) units 106. The S/P converter 101 divides transmission data into a plurality of data sequences before encoding the transmission data. The encoders 102 encode the data sequences, respectively. After encoding, the QAM mappers 103 modulate the encoded data sequences based on a predetermined modulation scheme such as Binary Phase Shift Keying (BPSK), Quadrature Phase Shift Keying (QPSK), 16 QAM, and 64 QAM. The IFFTs 104 transform the modulated symbols into time domain signals, respectively. The CP inserters 105 insert a CP code for a guard interval into the time domain signals. Then, the DAC & RF unit 106 converts the CP inserted digital signals to analog signals and covert the analog signals to RF signals. The RF signals are transmitted through an antenna.

Referring to FIG. 1B, the receiving part includes a plurality of analog-to-digital conversion (ADC) and radio frequency (RF) units 107, a plurality of CP removers 108, a plurality of Fast Fourier Transformers (FFT) 109, an MIMO receiver, a plurality of decoders 111, and a P/S converter 112. The ADC & RF units 107 convert RF signals to analog signals and convert the analog signals to digital signals. The CP removers 108 remove CP codes which were inserted for a guard interval and transfer the CP code removed signals to the FFTs 109. The FFTs 109 perform FFT on the input parallel signals which are the CP removed signals. The MIMO receiver 110 estimates transmission data symbols which are generated by FFT. The MIMO receiver 110 calculates a log likelihood ratio (LLR) from the estimated symbols. The decoders 111 decode data rows transferred from the MIMO receiver 110 and estimate the transmission data, respectively. The P/S converters 112 convert parallel data modulated by each decoder 111 into serial data.

The MIMO receiver 110 generally uses a decision feedback equalizer (DFE), zero forcing (ZF), minimum mean square error estimation (MMSE), and bell labs layered space-time (BLAST). As described above, the MIMO receiver has a problem of low performance although the MIMO receiver has a comparative simple structure compared to maximum likelihood detection (MLD).

### DISCLOSURE

Technical Problem

An embodiment of the present invention is directed to providing a Multiple Input Multiple Output (MIMO) receiver for reducing delay in a multi-dimensional receiving process by repeatedly processing predetermined columns and simultaneously processing symbol detection in parallel when QR decomposition is performed in a receiver of Orthogonal Frequency Division Multiplexing (OFDM) MIMO system, a QR decomposition apparatus and method used in the receiver, and a multi-dimensional detection apparatus and method used in the receiver.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

Technical Solution

In accordance with an aspect of the present invention, there is provided a receiver of a Multiple Input Multiple Output (MIMO) system, including: a QR decomposing unit for performing a QR decomposing operation in cycles 1 to n_{T}-n−1, and performing a column exchanging operation in cycles n_{T}-n to n_{T} as QR decomposition where n and T are an integer number; and a multi-dimensional detecting unit for receiving a first R matrix R_{y} and a second R matrix R_{z} from the QR decomposing unit, calculating a first distance value for detecting an m^{th} symbol for the first R matrix and a second distance value for detecting an m^{th} symbol for the second R matrix, and simultaneously detecting an m^{th} symbol and an (m−1)^{th} symbol using the first distance value and the second distance value.

In accordance with another aspect of the present invention, there is provide a QR decomposition apparatus used in a receiver of a Multiple Input Multiple Output (MIMO) system, including: a norm calculating unit for calculating a vector size norm for a channel input; a Q column calculating unit for calculating a column value of an unitary matrix Q using the channel input and \sqrt{norm}; a R row calculating unit for calculating a row value of an upper triangular matrix R by receiving the channel input, the output of the Q column calculating unit, and the 1/\sqrt{norm}; a Q update calculating unit for receiving the channel input, the output of the R column calculating unit, and the output of the Q row calculating unit, and outputting a Q update matrix value; a norm update calculating unit for receiving the output of the norm calculating unit and the output of the R row calculating unit and outputs a norm update matrix value; and a column exchanging unit for column-exchanging a norm value, a Q column value, and a R row value in cycles nT-n to nT where n and T are a natural number, wherein the Q column calculating unit, the R row calculating unit, the Q update calculating unit, and the norm update calculating unit perform calculation using the column-exchanged norm value, the column-exchanged Q column value, and the column-exchanged R row value.

In accordance with another embodiment of the present invention, there is provided a QR decomposition method in a receiver of a Multiple Input Multiple Output (MIMO) system, including the steps of: a) calculating a vector size norm for a channel input; b) calculating a column value of an unitary matrix Q using the channel input and \sqrt{norm}; c) calculating a row value of an upper triangular matrix R by receiving the channel input, the Q column value, and the 1/\sqrt{norm}; d) calculating a Q update matrix value using the channel input, the R column value, and the Q row value; e) calculating a norm update matrix value using the norm value and the R matrix value; and f) column-exchanging a norm value, a Q column value, and a R row value in cycles n_{T}-n to n_{T} where n and T are a natural number, and performing additional QR calculation using the column-exchanged norm value, the column-exchanged Q column value, and the column-exchanged R row value.

In accordance with another embodiment of the present invention, there is provided a multi-dimensional detecting apparatus used in a receiver of a Multiple Input Multiple Output (MIMO) system, including: a symbol detecting unit for receiving a first R matrix R_{y} and a second R matrix R_{z} from a QR decomposing apparatus as a QR decomposition result of cycles 1 to n_{T}-n−1 and a QR decomposition result additionally calculated through column exchanging, calculating a first distance value for detecting an m^{th} symbol for the first R matrix and a second distance value for detecting an m^{th} symbol for the second R matrix, and simultaneously detecting an m^{th} symbol and an (m−1)^{th} symbol using the first distance value and the second distance value.

In accordance with another embodiment of the present invention, there is provided a multi-dimensional detecting method used in a receiver of a Multiple Input Multiple Output (MIMO) system, including the steps of: a) generating symbols; b) receiving a first R matrix R_{y} and a second R matrix R_{z} from a QR decomposing apparatus as a QR decomposition result of cycles 1 to n_{T}-n−1 and a QR decomposition result additionally calculated through column exchanging, receiving the generated symbols, calculating a first distance value for detecting an m^{th} symbol for the first R matrix and a second distance value for detecting an m^{th} symbol for the second R matrix; and c) simultaneously detecting an m^{th} symbol and an (m−1)^{th} symbol using the first distance value and the second distance value.

Advantageous Effects

According to the present invention, a processing delay time can be reduced in a multi-dimensional receiving process by repeatedly processing predetermined columns and simultaneously processing symbol detection in parallel when QR decomposition is performed in a receiver of an MIMO system.

### BRIEF DESCRIPTION OF THE DRAWINGS

FIGS. 1A and 1B are block diagrams schematically illustrating a multiple input multiple output (MIMO) orthogonal frequency division multiplexing (OFDM) system.

FIG. 2 is a block diagram illustrating a transmitter of an OFDM MIMO system where the present invention is applied to.

FIG. 3 is a block diagram illustrating a receiver of an OFDM MIMO system where the present invention is applied to.

FIG. 4 is a block diagram illustrating a QR decomposition apparatus in accordance with an embodiment of the present invention.

FIG. 5 is a diagram for describing a Q matrix and a R matrix by additional QR decomposition in accordance with an embodiment of the present invention.

FIG. 6 illustrates a multi-dimensional detection apparatus (MDD) in accordance with an embodiment of the present invention.

FIG. 7 is a block diagram illustrating a symbol hard-decision and symbol distance calculator in accordance with an embodiment of the present invention.

### BEST MODE FOR THE INVENTION

The advantages, features and aspects of the invention will become apparent from the following description of the embodiments with reference to the accompanying drawings, which is set forth hereinafter.

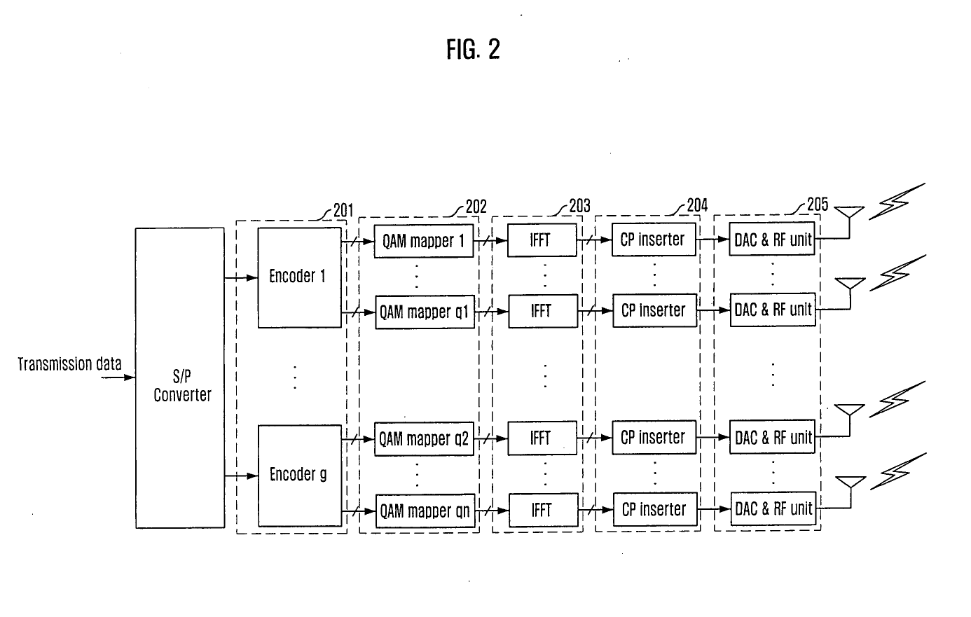

FIG. 2 is a block diagram illustrating a transmitter of an MIMO-OFDM system where the present invention is applied to.

Referring to FIG. 2, the transmitter includes a serial-to-parallel converter, a plurality of encoders 201, a plurality of Inverse Fast Fourier Transformers (IFFT) 203, a plurality of cyclic prefix (CP) adders 204, and a plurality of digital-to-analog conversion (DAC) & radio frequency (RF) units 205. The transmitter receives data from a transmission antenna. The S/P converter converts the received data to parallel data sequences and outputs the parallel data sequences to the g encoders 201 where g is an integer number. Each of the g encoders 201 is connected to q QAM mappers 202, respectively. Each of the QAM mappers 202 may have a different channel coding rate and modulation scheme.

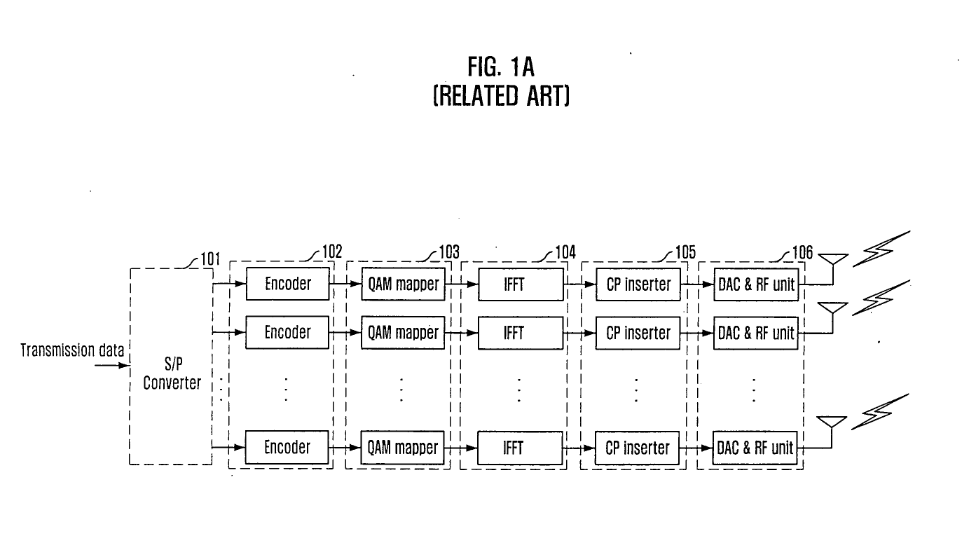

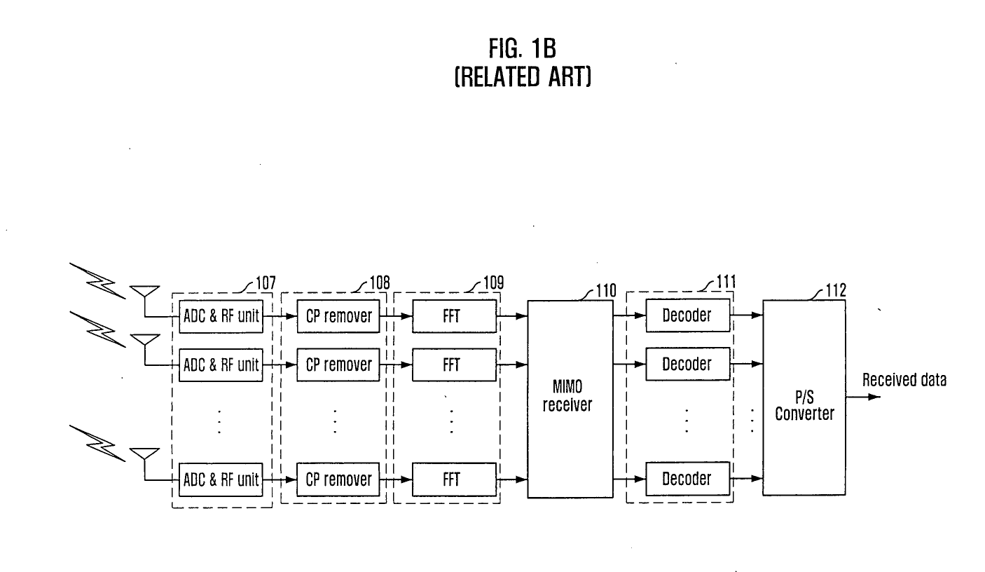

The plurality of QAM mappers 202 are sequentially connected to the plurality of IFFTs 203, the CP adders 204, and the DAC & RF units 205, respectively. Since the operations of the QAM mappers 202, the IFFTs 203, the CP adders 204, and the DAC and RF units 205 are identical to those of constituent elements shown in FIG. 1A, the detail descriptions thereof are omitted.

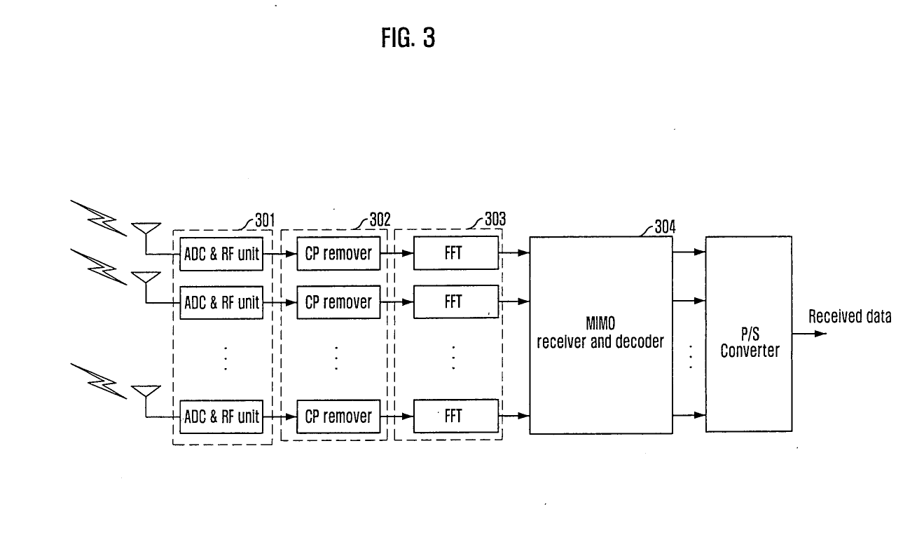

FIG. 3 is a block diagram illustrating a receiver of an OFDM MIMO system to which the present invention applied.

Referring to FIG. 3, the receiver includes a plurality of analog-to-digital conversion (ADC) & radio frequency (RF) units 301, a plurality of cyclic prefix (CP) removers 302, a plurality of Fast Fourier Transformers (FFT) 303, an MIMO receiver and a decoder 304, and a parallel-to-serial (P/S) converter. The plurality of ADC & RF units 301 convert a radio frequency (RF) signal to an analog signal and convert the analog signal to a digital signal. The plurality of CP removers 302 remove a cyclic prefix (CP) code which is inserted for a guard interval. The FFTs 303 perform FFT on the CP removed parallel signal.

The MIMO receiver and decoder 304 are a multi-dimensional receiver and decoder that demodulate the received symbols from the plurality of FFTs 303.

If it is assumed that the receiver includes M transmission antennas and N receipt antennas, a received signal vector z can be expressed as Eq. 1 in a sub carrier after FFT.

z=Hs+n Eq. 1

In Eq. 1, the received signal vector Z can be expressed as

$$z = [ \begin{matrix}{z}_{1} \\ {z}_{2} \\ ⋮ \\ {z}_{N}\end{matrix} ] ,$$

a channel H can be expressed as

$$H = [ \begin{matrix}{h}_{1 , 1} & {h}_{1 , 2} & … & {h}_{1 , M} \\ {h}_{2 , 1} & {h}_{2 , 2} & … & {h}_{2 , M} \\ ⋮ & ⋮ & ⋰ & ⋮ \\ {h}_{N , 1} & {h}_{N , 2} & … & {h}_{N , M}\end{matrix} ] ,$$

and a transmission symbol s can be expressed as

$$s = [ \begin{matrix}{s}_{1} \\ {s}_{2} \\ ⋮ \\ {s}_{M}\end{matrix} ] .$$

The channel H can be expressed as H=QR after QR decomposition. Here, R denotes an upper triangular matrix. Since the MIMO system includes N antennas for receiving a signal and M antennas for transmitting a signal, the upper triangular matrix R can be expressed as follow.

$$R = {Q}^{″} H = [ \begin{matrix}{r}_{1 , 1} & {r}_{1 , 2} & … & {r}_{1 , M} \\ 0 & {r}_{2 , 2} & … & {r}_{2 , M} \\ ⋮ & ⋮ & ⋰ & ⋮ \\ 0 & 0 & … & {r}_{M , M} \\ 0 & 0 & … & 0 \\ ⋮ & ⋮ & ⋰ & ⋮ \\ 0 & 0 & … & {0}_{N , M}\end{matrix} ]$$

Q denotes a Unitary matrix (Q^{H}Q=I). Since the channel matrix H is N×M, the unitary matrix Q is N×N and the upper triangular matrix R is N×M. The unitary matrix Q can be expressed as follow.

$$Q = [ \begin{matrix}{q}_{1 , 1} & {q}_{1 , 2} & {q}_{1 , 3} & {q}_{1 , 4} & … & {q}_{1 , N} \\ {q}_{2 , 1} & {q}_{2 , 2} & {q}_{2 , 3} & {q}_{2 , 4} & … & {q}_{2 , N} \\ {q}_{3 , 1} & {q}_{3 , 2} & {q}_{3 , 3} & {q}_{3 , 4} & … & {q}_{3 , N} \\ {q}_{4 , 1} & {q}_{4 , 2} & {q}_{4 , 3} & {q}_{4 , 4} & … & {q}_{4 , N} \\ ⋮ & ⋮ & ⋮ & ⋮ & ⋰ & ⋮ \\ {q}_{N , 1} & {q}_{N , 2} & {q}_{N , 3} & {q}_{N , 4} & … & {q}_{N , N}\end{matrix} ]$$

After QR decomposition, a received signal can be expressed as Eq. 2.

$$\begin{matrix}y = [ \begin{matrix}{y}_{1} \\ {y}_{2} \\ ⋮ \\ {y}_{N}\end{matrix} ] \\ = {Q}^{H} z \\ = Rs + {n}^{′} \\ = [ \begin{matrix}{r}_{1 , 1} & {r}_{1 , 2} & … & {r}_{1 , M} \\ 0 & {r}_{22} & … & {r}_{2 , M} \\ 0 & ⋮ & ⋰ & ⋮ \\ 0 & … & 0 & {r}_{N , M}\end{matrix} ] [ \begin{matrix}{s}_{1} \\ {s}_{2} \\ ⋮ \\ {s}_{M}\end{matrix} ] + [ \begin{matrix}{n}_{1}^{′} \\ {n}_{2}^{′} \\ ⋮ \\ {n}_{N}^{′}\end{matrix} ]\end{matrix} \qquad Eq . 2$$

Eq. 2 can be simplified as follow.

$$\begin{matrix}y = [ \begin{matrix}{y}_{1} \\ {y}_{2} \\ ⋮ \\ {y}_{M}\end{matrix} ] \\ = {Q}^{H} z \\ = Rs + {n}^{′} \\ = [ \begin{matrix}{r}_{1 , 1} & {r}_{1 , 2} & … & {r}_{1 , M} \\ 0 & {r}_{22} & … & {r}_{2 , M} \\ 0 & ⋮ & ⋰ & ⋮ \\ 0 & … & 0 & {r}_{M , M}\end{matrix} ] [ \begin{matrix}{s}_{1} \\ {s}_{2} \\ ⋮ \\ {s}_{M}\end{matrix} ] + [ \begin{matrix}{n}_{1}^{′} \\ {n}_{2}^{′} \\ ⋮ \\ {n}_{M}^{′}\end{matrix} ]\end{matrix}$$

The MIMO receiver according to the present embodiment includes a QR decomposition unit, a multi-dimensional detector (MDD), an inverse matrix and weight calculator, an interference remover, and a weight zero forcing (WZF) unit.

The QR decomposition unit calculates the unitary matrix Q, the upper triangular matrix R, and a vector size (norm) from the received signal vector z during a long training field (LTF) period. The QR decomposition unit stores the calculated unitary matrix Q and the upper triangular matrix R, vector sizes (norm) for each element of the unitary matrix Q. Here, the normᵢ is equivalent to ∥qᵢ∥².

A signal field detector performs detection for a signal field from an output vector of the QR decomposing unit in a SIG interval. The inverse matrix and weight calculator calculates an inverse matrix of the upper triangular matrix R during first two symbol intervals among symbols for receiving data symbols using the calculated upper triangular matrix R and the vector size (1/\sqrt{norm}). The multi-dimensional detector MDD calculates a log likelihood ratio (LLR) through multiple detections using the output vector y and the upper triangular matrix value of the QR decomposition. The calculated LLR value is inputted to a channel decoder, and used to demodulate the signal.

The interference remover receives the data stream demodulated by the channel decoder, generates symbols corresponding to a data stream demodulated through symbol mapping, and removes interference from the output vector, which is the QR decomposition result, using the generated symbol. The WZF unit performs zero-forcing using the interference removed output vector and the inverse matrix of the upper triangular matrix R. The channel decoder receives the LLR value outputted from the WZF unit and uses the LLR value to demodulate signals.

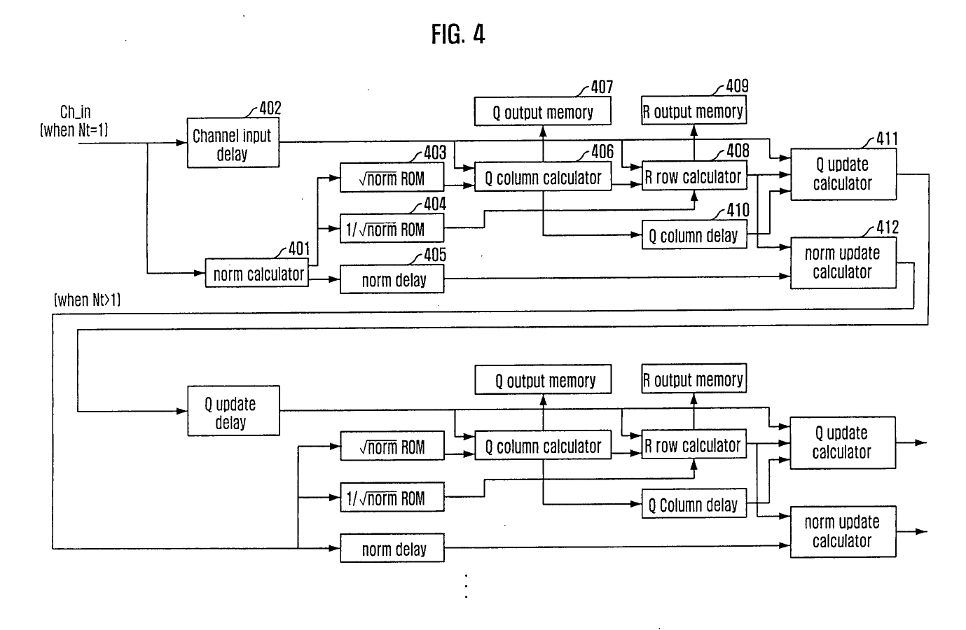

FIG. 4 is a block diagram illustrating a QR decomposition apparatus in accordance with an embodiment of the present invention.

Referring to FIG. 4, the QR decomposition apparatus according to the present embodiment includes a norm calculator 401, a channel input delay 402, lookup table ROMs 403 and 404, a norm delay 405, a Q column calculator 406, a Q output memory 407, a R row calculator 408, a R output memory 409, a Q column delay 410, a Q update calculator 411, and a norm update calculator 412.

The norm calculator 401 calculates a vector size norm. The norm calculator 401 receives a channel input after Fast Fourier Transform (FFT) and calculates the vector size norm for qᵢ through normᵢ=∥qᵢ∥². The channel input delay 402 delays the channel input qᵢ in order to use it for calculating a column value of a Q matrix and a row value of an R matrix. The output of the norm calculator 401 is inputted to each of the lookup table ROMs 403 and 404, respectively. Each of the ROMs 403 and 404 outputs and \sqrt{norm} and 1/\sqrt{norm} corresponding to the inputted vector size norm through calculation r_{i,j}=\sqrt{norm}. Also, the output of the norm calculator 401 is delayed by the norm delay 405 for updating a norm value to be used in a following step.

The Q column calculator 406 receives the value outputted from the ROM 403 and the delayed qᵢ from the channel input delay 402, and outputs a Q column value by performing calculation qᵢ:=qᵢ/r_{i,j}. Since the Q column value calculated by the Q column calculator 406 is the result of a QR matrix used for multiple antennas receiving decoding, the Q column value is stored in the Q output memory 407. The calculated Q column value qᵢ from the Q column calculator 406 is inputted to the Q column delay 408 and delayed to be used for Q matrix update to be used in a next step.

The R row calculator 409 receives the calculated Q column value from the Q column calculator 406, the delayed channel input from the channel input delay 402, and 1/\sqrt{norm} from the ROM 404, and calculates a R row value through calculation r_{i,j}=qᵢ^{H}×qₖ. The value 1/\sqrt{norm} outputted from the ROM 404 is used as a diagonal value of an R row. Since the R row value (r_{i,j}) calculated by the R row calculator 409 is the first row value of the R matrix in the QR decomposition, the R row value (r_{i,j}) is stored in the R output memory 410.

The Q update calculator 411 receives the delayed value from the channel input delay 402, the delayed Q column value from the Q column delay, and the R row value from the R row calculator and updates a Q value through calculation qₖ=qₖ−r_{i,j}×qᵢ.

The norm update calculator 412 receives the delayed norm value from the norm delay 405, and the R row value from the R row calculator, and updates the norm value through calculation normₖ:=normₖ−r_{i,k}².

The above described processes are the QR decomposition procedure when Nₜ=1. QR decomposition values from the second antenna to an N^{th} antenna in the multiple antenna wireless communication system are calculated through the same QR decomposition procedure that is described above. Therefore, the output value of the Q update calculator 411 is inputted to the Q update delay at a next cycle and the output value of the norm update calculator 412 is inputted to lookup table ROMs, respectively, at a next cycle for calculating \sqrt{norm} and 1/\sqrt{norm}. As described above, the QR decomposition procedure is repeated as many as the number of multiple antennas.

In order to decide a 8^{th} symbol and a 7^{th} symbol at the same time in the multi-dimensional detection in the present embodiment, the QR decomposition is improved as shown in Eq. 3 in the present embodiment. That is, an additional partial QR decomposition calculation is performed through column exchanging when the QR decomposition is performed for last two columns. Through the partial QR decomposition calculation, the last two columns of the Q matrix are additionally calculated, and the last two rows of the R matrix are also additionally calculated. The computation amount of the additional calculation performed through such column exchanging is not large, for example, about 4%. Eq. 3 shows the improved QR calculation according to the present embodiment.

```
R = 0,Q = H
for i = 1,...,n_{T}
  normᵢ =|| qᵢ ||²
end
for i = 1,...,n_{T} − 2
  r_{i,i} = \sqrt{normᵢ}
  qᵢ := qᵢ / r_{i,i}
  for k = i + 1,...,n_{T}
    r_{i,k} = qᵢ^{H} · qₖ
    qₖ := qₖ − r_{i,k} · qᵢ
    normₖ := normₖ − r_{i,k}²
  end
end
norm₍ₙ_{_{T}}_{-1)z} = normₙ_{_{T}} , normₙ_{_{T}}_{z} = norm₍ₙ_{_{T}}₋₁₎
q₍ₙ_{_{T}}_{-1)z} = qₙ_{_{T}}, qₙ_{_{T}}_{z} = q₍ₙ_{_{T}}₋₁₎
r₍ₙ_{_{T}}_{-1)z} = rₙ_{_{T}}, rₙ_{_{T}}_{z} = r₍ₙ_{_{T}}₋₁₎
for i = n_{T} − 1 to n_{T}
  r_{i,i} = \sqrt{normᵢ}, r_{iz,iz} = \sqrt{norm_{iz}}
  qᵢ := qᵢ / r_{i,i}, q_{iz} := q_{iz} / r_{iz,iz}
  for k = i + 1,...,n_{T}
    r_{i,k} = qᵢ^{H} · qₖ, r_{iz,kz} = q_{iz}^{H} · q_{kz}
    qₖ := qₖ − r_{i,k} · qᵢ, q_{kz} := q_{kz} − r_{iz,kz} · q_{iz}
    normₖ := normₖ − r_{i,k}², norm_{kz} := norm_{kz} − r_{iz,kz}²
  end
end
```

where n_{T} denotes the number of transmission antennas.

Eq. 3

As shown in Eq. 3, a Q matrix value and an R matrix value are calculated by performing the normᵢ calculation operation in cycles 1 to n_{T}, performing the \sqrt{norm} calculation operation, the Q column calculation operation, the R row calculation operation, the Q update operation, and the norm update operation in cycles 1 to n_{T}-2. When QR decomposition is performed at cycles n_{T}-1 and n_{T}, a column of a n_{T}-1 value is exchanged with a column of an n_{T} value for norm, a Q matrix value, and an R matrix value, and the \sqrt{norm} calculation operation, the Q column calculation operation, the R row calculation operation, the Q update operation, and the norm update operation are performed using the exchanged value. Through such a partial QR decomposition, the last two columns of the Q matrix are additionally calculated, and the last two row of the R matrix are additionally calculated.

The example of the additional QR decomposition calculation can be easily expanded to performing QR decomposition until a cycle n_{T}-n and additionally calculating n columns through column exchanging for the last n columns as shown in Eq. 4.

norm₍ₙ_{₁}_{-(n-1))zn}=normₙ_{₁}·normₙ_{₁}_{zn}=norm₍ₙ_{₁}₋₍ₙ₋₁₎₎

q₍ₙ_{_{T}}_{-(n-1))zn}=qₙ_{_{T}}, qₙ_{_{T}}_{zn}=q₍ₙ_{_{T}}₋₍ₙ₋₁₎₎

r₍ₙ_{_{T}}_{-(n-1))zn}=rₙ_{_{T}}, rₙ_{_{T}}_{zn}r₍ₙ_{_{T}}₋₍ₙ₋₁₎₎

. . .

norm₍ₙ_{_{T}}_{-(n-2))zn1}=normₙ_{_{T}}, normₙ_{_{T}}_{zn1}=norm₍ₙ_{_{T}}₋₍ₙ₋₂₎₎

q₍ₙ_{_{T}}_{-(n-2))zn1}=qₙ_{_{T}}, qₙ_{_{T}}_{zn1}=qₙ_{_{T}}₋₍ₙ₋₂₎₎

r₍ₙ_{_{T}}_{-(n-2))zn1}=rₙ_{_{T}}, rₙ_{_{T}}_{zn1}=r₍ₙ_{_{T}}₋₍ₙ₋₂₎₎

. . .

. . .

norm₍ₙ_{_{T}}_{-1)z}=norm_{N}_{_{T}}, normₙ_{_{T}}_{z}=norm₍ₙ_{_{T}}₋₁₎

q₍ₙ_{_{T}}_{-1)z}=qₙ_{_{T}}, qₙ_{_{T}}_{z}=q₍ₙ_{_{T}}₋₁₎

r₍ₙ_{_{T}}_{-1)z}=rₙ_{_{T}}, rₙ_{_{T}}_{z}=r₍ₙ_{_{T}}₋₁₎ Eq. 4

If Q_{y}, R_{y} and Q_{z}, R_{z} denote a Q matrix and an R matrix respectively when two columns are added, Q_{y}^{H}z and Q_{z}^{H}z can be expressed like Eq. 5. The last symbols at y_{y} and y_{z} are S_{M} and S_{M-1}, and the last symbols S_{M} and S_{M-1} can be detected through the multi-dimensional detector.

$$\begin{matrix}{y}_{y} = [ \begin{matrix}{y}_{y , 1} \\ ⋮ \\ {y}_{y , M - 2} \\ {y}_{y , M - 1} \\ {y}_{y , M}\end{matrix} ] \\ = {Q}_{y}^{H} z \\ = {R}_{y} s + {n}_{y}^{′} \\ = [ \begin{matrix}{r}_{1 , 1} & … & {r}_{1 , M - 2} & {r}_{1 , M - 1} & {r}_{1 , M} \\ 0 & ⋰ & … & … & … \\ 0 & … & {r}_{M - 2 , M - 2} & {r}_{M - 2 , M - 1} & {r}_{M - 2 , M} \\ 0 & … & 0 & {r}_{y , M - 1 , M - 1} & {r}_{y , M - 1 , M} \\ 0 & … & 0 & 0 & {r}_{y , M , M}\end{matrix} ] [ \begin{matrix}{s}_{1} \\ ⋮ \\ {s}_{M - 2} \\ {s}_{M - 1} \\ {s}_{M}\end{matrix} ] + \\ [ \begin{matrix}{n}_{y , 1}^{′} \\ ⋮ \\ {n}_{y , M - 2}^{′} \\ {n}_{y , M - 1}^{′} \\ {n}_{y , M}^{′}\end{matrix} ]\end{matrix} \\ \begin{matrix}{y}_{z} = [ \begin{matrix}{y}_{z , 1} \\ ⋮ \\ {y}_{z , M - 2} \\ {y}_{z , M - 1} \\ {y}_{z , M}\end{matrix} ] \\ = {Q}_{z}^{H} z \\ = {R}_{z} s + {n}_{y}^{′} \\ = [ \begin{matrix}{r}_{1 , 1} & … & {r}_{1 , M - 2} & {r}_{1 , M} & {r}_{1 , M - 1} \\ 0 & ⋰ & … & … & … \\ 0 & … & {r}_{M - 2 , M - 2} & {r}_{M - 2 , M} & {r}_{M - 2 , M - 1} \\ 0 & … & 0 & {r}_{z , M - 1 , M - 1} & {r}_{z , M - 1 , M} \\ 0 & … & 0 & 0 & {r}_{z , M , M}\end{matrix} ] [ \begin{matrix}{s}_{1} \\ ⋮ \\ {s}_{M - 2} \\ {s}_{M} \\ {s}_{M - 1}\end{matrix} ] + \\ [ \begin{matrix}{n}_{z , 1}^{′} \\ ⋮ \\ {n}_{z , M - 2}^{′} \\ {n}_{z , M - 1}^{′} \\ {n}_{z , M}^{′}\end{matrix} ]\end{matrix} \qquad Eq . 5$$

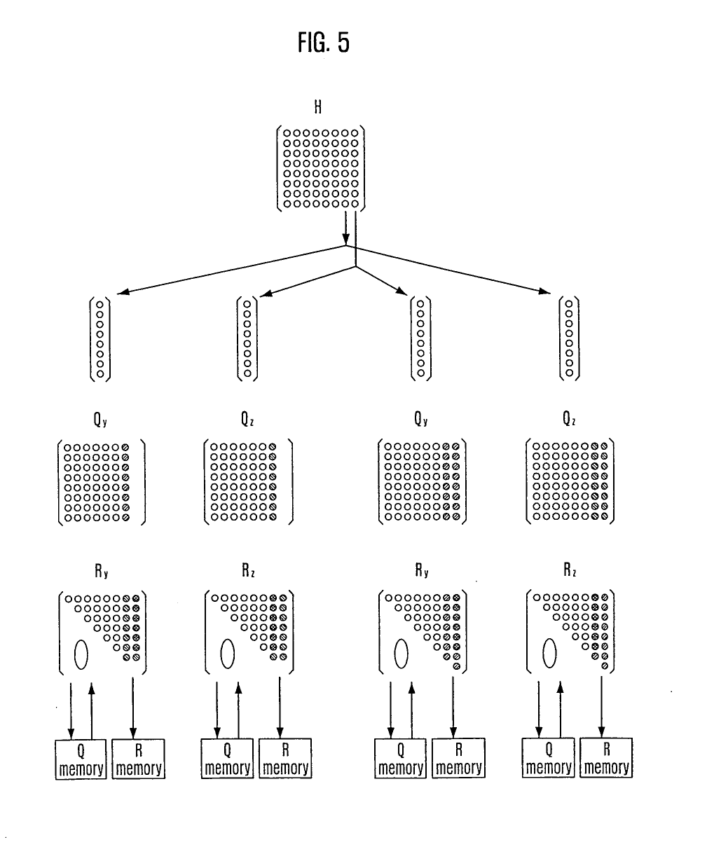

In case of an 8×8 matrix, the last two columns of the Q matrix and the R matrix are like FIG. 5.

FIG. 5 shows an example of calculating the last two columns additionally in QR decomposition for an 8×8 matrix. In FIG. 5, only last two columns of two Q matrices are different from a sixth of the last two columns, and a 7th row and a 8th row of the last two columns have different values.

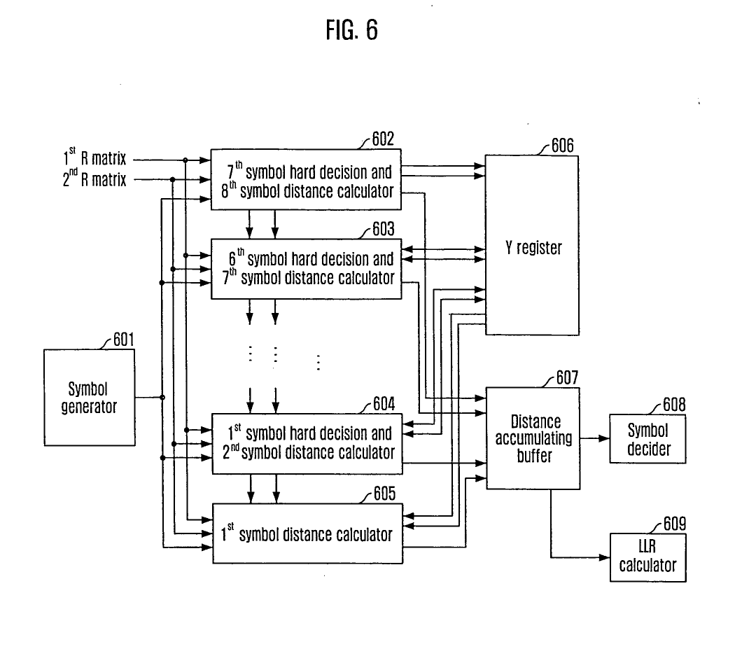

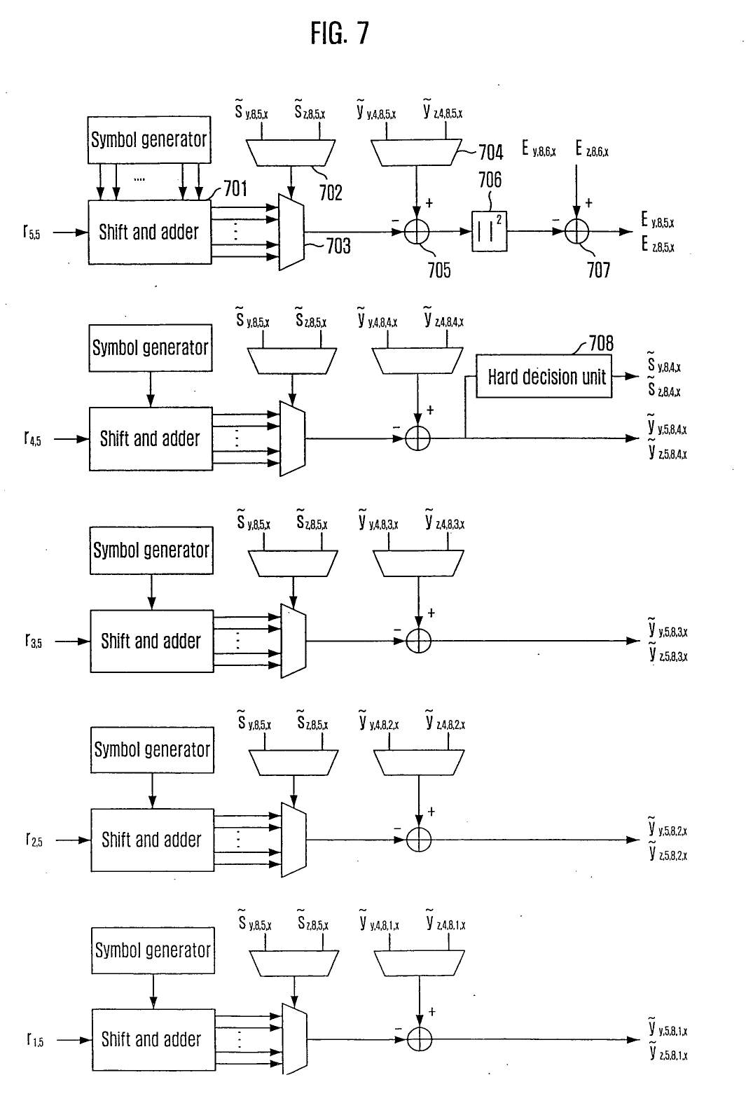

A multi-dimensional detection apparatus according to an embodiment of the present invention will be described with reference to FIGS. 6 and 7.

FIG. 6 is a diagram illustrating a multi-dimensional detection apparatus (MDD) in accordance with an embodiment of the present invention.

Referring to FIG. 6, the multi-dimensional detection apparatus according to the present embodiment includes a symbol generator 601, a 7^{th} symbol hard-decision and 8^{th} symbol distance calculator 602, a 6^{th} symbol hard-decision and 7^{th} symbol distance calculator 603, a 1^{st} symbol hard-decision and 2^{nd} symbol distance calculator 604, a first symbol distance calculator 605, a Y register 606, a distance accumulating buffer 607, a symbol decider 608, and an LLR calculator 609.

The symbol generator 601 generates a symbol having lattice points. For example, in case of 16 QAM, a symbol has 16 lattice points. That is, there are 16 distances existed.

The 7^{th} symbol hard-decision and 8^{th} distance calculator 602 receives a first matrix R_{y} and a second matrix R_{z} from the QR decomposition apparatus as a QR decomposition result in cycles 1 to n_{T}-n−1 and additional QR decomposition result calculated through n_{T}-n to n_{T} column exchanging, and receives a symbol generated from the symbol generator 601. The 7^{th} symbol hard decision and 8^{th} symbol distance calculator 602 calculates a updated first receiving signal \tilde{y}_{y} by performing a first multiplying operation for multiplying an element of the first R matrix and the 8^{th} symbol from the symbol generator, performing a second multiplying operation for multiplying a constant of Eq. 12 and a first receiving signal y_{y}, and subtracting the result of the first multiplying operation from the result of the second multiplying operation. Here, the 8^{th} element and the 7^{th} element of the updated first receiving signal use the 8^{th} element and the 7^{th} element of the added first R matrix.

The 7^{th} symbol hard decision and 8^{th} symbol distance calculator 602 calculates a second receiving signal \tilde{y}_{z} updated by multiplying an R element and a 7^{th} symbol and subtracting the multiplying result from the second receiving signal. Here, the 8^{th} element and the 7^{th} element of the updated second receiving signal use the 8^{th} element and the 7^{th} element of the added second R matrix.

The calculated first and second receiving signals \tilde{y}_{y}, \tilde{y}_{z} are stored in the y register 606.

The 7^{th} symbol hard decision and 8^{th} symbol distance calculator 602 calculates a distance value of a 8^{th} symbol for detecting a 8^{th} symbol of a first receiving signal and performs hard decision on a 7^{th} symbol of the first receiving signal. The 7^{th} symbol hard decision and 8^{th} symbol distance calculator 602 calculates a distance value of a 8^{th} symbol for detecting a 8^{th} symbol of the second receiving signal and performs hard decision on a 7^{th} symbol of the second receiving signal.

The 6^{th} symbol hard decision and 7^{th} symbol distance calculator 603 updates the updated first receiving signal again by multiplying an element of a first R matrix and the hard decision result of the 7^{th} symbol of the first receiving signal and subtracting the multiplying result from the updated first receiving signal stored in the y register 606. Here, the 7^{th} element of the first receiving signal uses a 7^{th} element of an added first R matrix. Then, the 6^{th} symbol hard decision and 7^{th} symbol distance calculator 603 calculates a distance value of a 7^{th} symbol for detecting a 8^{th} symbol of the first receiving signal and performs hard decision on a 6^{th} symbol of the first receiving signal.

The 6^{th} symbol hard decision and 7^{th} symbol distance calculator 603 updates the updated second receiving signal again by multiplying an element of the second R matrix and the hard decision result of the 7^{th} symbol of the second receiving signal and subtracting the multiplying result from the updated second receiving signal stored in the y register 606.

Here, the 7^{th} element of the updated second receiving signal uses an added 7^{th} element of a second R matrix. And, the 6^{th} symbol hard decision and 7^{th} symbol distance calculator 603 calculates a distance value of a 7^{th} symbol for detecting a 8^{th} symbol of a second receiving signal and performs hard decision on a 6^{th} symbol of the second receiving signal. Then, the updated first receiving signal and the updated second receiving signal are stored in the y register 606.

The 5^{th} symbol hard decision and 6^{th} symbol distance calculator updates the updated first receiving signal again by multiplying an element of a first R matrix and the hard decision result of the 6^{th} symbol of the first receiving signal and subtracting the multiplying result from the updated first receiving signal stored in the y register 606. Then, the 5^{th} symbol hard decision and 6^{th} symbol distance calculator calculates a distance value of a 6^{th} symbol for detecting an 8^{th} symbol of the first receiving signal and performs hard decision on a 5^{th} symbol of the first receiving signal.

The 5^{th} symbol hard decision and 6^{th} symbol distance calculator updates the updated second receiving signal again by multiplying an element of a second R matrix with the hard decision result of the 6^{th} symbol of the second receiving and subtracting the multiplying result from the updated second receiving signal stored in the y resister 606. Then, the 5^{th} symbol hard decision and 6^{th} symbol distance calculator calculates a distance value of a 6^{th} symbol for detecting a 8^{th} symbol of a second receiving signal and performs hard decision for 5^{th} symbol of the second receiving signal. Then, the updated first updated signal and the updated second receiving signal are stored in the y register 606.

By performing the same procedure described above, a 5^{th} symbol distance, a 4^{th} symbol distance, a 3^{rd} symbol distance, a 2^{nd} symbol distance and a 1^{st} symbol distance are calculated for detecting a 8^{th} symbol.

The distance accumulating buffer 607 accumulates the distance values of each symbol element and stores the accumulated distance value for detecting an 8^{th} symbol. The distance values stored in the distance accumulating buffer 607 are transferred to the LLR calculator 609 and the symbol decider 608.

The symbol decider 608 decides a symbol having a minimum value among the distance values calculated for detecting an 8^{th} symbol using a first R matrix as a 8^{th} symbol and decides a symbol having a minimum value among the distance values calculated for detecting a 8^{th} symbol using a second R matrix. The LLR calculator 609 calculates an LLR for a 8^{th} symbol and an LLR for a 7^{th} symbol using the calculated distance values.

The process of deciding the 8^{th} symbol and the 7^{th} symbol can be described as a cycle as follows.

In \tilde{y}_{y,1,8,8,x}, a first subscript y is shown as a y_{y} vector in Eq. 5, a second subscript denotes a cycle, a third subscript denotes a symbol number to estimate, a fourth subscript is an element number of a y vector, and a fifth subscript x denotes the number of symbols generated by the symbol generator. The fifth subscript x may be smaller than 4 in case of QPSK, smaller than 16 in case of 16 QAM, and smaller than 64 in case of 64 QAM. In E_{y,8,8,x}, a first subscript y denotes a subscript y of Eq. 5, a second subscript denotes a symbol number to estimate, a fourth subscript is an element number of a vector for calculating a distance value, and a fourth subscript denotes the number of symbols generated from the symbol generator. In \tilde{s}_{y,8,7,x}, a first subscript denotes a subscript y of Eq. 5, a second subscript denotes a symbol number to estimate, a third subscript is an element number of a vector for hard decision, and a fourth subscript is the number of symbols generated from the symbol generator. The first cycle can be expressed as Eq. 6.

\tilde{y}_{y,1,8,8,x}=Cy_{y,8}−r_{y,8,8}s_{8,x}

\tilde{y}_{y,1,8,7,x}=Cy_{y,7}−r_{y,7,8}s_{8,x}

\tilde{y}_{y,1,8,6,x}=Cy_{y,6}−r_{6,8}s_{8,x}

. . .

\tilde{y}_{y,1,8,1,x}=Cy_{y,1}−r_{1,8}s_{8,x}

E_{y,8,8,x}=|\tilde{y}_{y,1,8,8,x}|²

\tilde{s}_{y,8,7,x}=hard decision(\tilde{y}_{y,1,8,7,x}/r_{y,7,7})

\tilde{y}_{z,1,8,8,x}=y_{z,8}−r_{z,8,8}s_{7,x}

\tilde{y}_{z,1,8,7,x}=y_{z,7}−r_{z,7,8}s_{7,x}

\tilde{y}_{z,1,8,6,x}=y_{z,7}−r_{z,6,7}s_{7,x}

. . .

\tilde{y}_{z,1,8,1,x}=y_{z,1}−r_{1,7}s_{7,x}

E_{z,8,8,x}−|\tilde{y}_{z,1,8,8,x}|²

\tilde{s}_{z,8,7,x}=hard decision(\tilde{y}_{z,1,8,7,x}/r_{z,7,7}) Eq. 6

A second cycle can be expressed as Eq. 7.

\tilde{y}_{y,2,8,7,x}=\tilde{y}_{y,1,8,7,x}−r_{y,7,7}\tilde{s}_{y,8,7,x}

\tilde{y}_{y,2,8,6,x}=\tilde{y}_{y,1,8,6,x}−r_{6,6}\tilde{s}_{y,8,7,x}

\tilde{y}_{y,2,8,5,x}=\tilde{y}_{y,1,8,5,x}−r_{5,7}\tilde{s}_{y,8,7,x}

. . .

\tilde{y}_{y,2,8,1,x}=\tilde{y}_{y,1,8,1,x}−r_{1,7}\tilde{s}_{y,8,7,x}

E_{y,8,7,x}=E_{y,8,8,x}+|\tilde{y}_{y,2,8,7,x}|²

\tilde{s}_{y,8,6,x}=hard decision(\tilde{y}_{y,2,8,6,x}/r_{6,6})

\tilde{y}_{z,2,8,7,x}=\tilde{y}_{z,1,8,7,x}−r_{z,7,7}\tilde{s}_{z,8,7,x}

\tilde{y}_{z,2,8,6,x}=\tilde{y}_{z,1,8,6,x}−r_{6,8}\tilde{s}_{z,8,7,x}

\tilde{y}_{z,2,8,5,x}=\tilde{y}_{z,1,8,5,x}−r_{5,8}\tilde{s}_{z,8,7,x}

. . .

\tilde{y}_{z,2,8,1,x}=\tilde{y}_{z,1,8,1,x}−r_{1,8}\tilde{s}_{z,8,7,x}

E_{z,8,7,x}=E_{z,8,8,x}+|\tilde{y}_{z,2,8,7,x}|²

\tilde{s}_{z,8,6,x}=hard decision(\tilde{y}_{z,2,8,6,x}/r_{6,6,} Eq. 7

A third cycle can be expressed as Eq. 8.

\tilde{y}_{y,3,8,6,x}=\tilde{y}_{y,2,8,6,x}−r_{6,6}\tilde{s}_{y,8,6,x}

\tilde{y}_{y,3,8,5,x}=\tilde{y}_{y,2,8,5,x}−r_{5,6}\tilde{s}_{y,8,6,x}

. . .

\tilde{y}_{y,3,8,1,x}=\tilde{y}_{y,2,8,1,x}−r_{1,6}\tilde{s}_{y,8,6,x}

E_{y,8,6,x}=E_{y,8,7,x}+|\tilde{y}_{y,3,8,6,x}|²

\tilde{s}_{y,8,5,x}=hard decision(\tilde{y}_{y,3,8,5,x}/r_{5,5})

\tilde{y}_{z,3,8,6,x}=\tilde{y}_{z,2,8,6,x}−r_{6,6}\tilde{s}_{z,8,6,x}

\tilde{y}_{z,3,8,5,x}=\tilde{y}_{z,2,8,5,x}−r_{5,6}\tilde{s}_{z,8,6,x}

. . .

\tilde{y}_{z,3,8,1,x}=\tilde{y}_{z,2,8,1,x}−r_{1,6}\tilde{s}_{z,8,6,x}

E_{z,8,6,x}=E_{z,8,7,x}+|\tilde{y}_{z,3,8,6,x}|²

\tilde{s}_{z,8,5,x}=hard decision(\tilde{y}_{z,3,8,5,x}/r_{5,5}) Eq. 8

The same procedure is repeated from a fourth cycle to a seventh cycle.

Then, a 8^{th} cycle is performed like Eq. 9.

\tilde{y}_{y,8,8,1,x}=\tilde{y}_{y,7,8,1,x}−r_{1,1}\tilde{s}_{y,8,1,x}

E_{y,8,1,x}=E_{y,8,2,x}+|\tilde{y}_{y,8,8,1,x}|²

\tilde{y}_{z,8,8,1,x}=\tilde{y}_{z,7,8,1,x}−r_{1,1}\tilde{s}_{z,8,1,x}

E_{z,8,1,x}=E_{z,8,2,x}+|\tilde{y}_{z,8,8,1,x}|² Eq. 9

Finally, an 8^{th} symbol and a 7^{th} symbol having a minimum value are selected at a 9^{th} cycle as shown in Eq. 10.

min(D_{y,8,1,x})=>\tilde{s}₈

min(D_{z,8,1,x})=>\tilde{s}₇ Eq. 10

The calculation of the LLRs of the 7^{th} symbol and the 8^{th} symbol can be expressed as Eq. 11 in p=(b₀b₁b₂b₃). Eq. 11 shows the LLR calculation for 16 QAM.

ρₖ⁰=min(E_{k,1,0},E_{k,1,1},E_{k,1,2},E_{k,1,3},E_{k,1,4},E_{k,1,5},E_{k,1,6},E_{k,1,7})−−min(E_{k,1,8},E_{k,1,9},E_{k,1,10},E_{k,1,11},E_{k,1,12},E_{k,1,13},E_{k,1,14},E_{k,1,15})

ρₖ¹=min(E_{k,1,0},E_{k,1,1},E_{k,1,2},E_{k,1,3},E_{k,1,8},E_{k,1,9},E_{k,1,10},E_{k,1,11})−min(E_{k,1,4},E_{k,1,5},E_{k,1,6},E_{k,1,7},E_{k,1,12},E_{k,1,13}E_{k,1,14},E_{k,1,15})

ρₖ²=min(E_{k,1,0},E_{k,1,4},E_{k,1,8},E_{k,1,12},E_{k,1,1},E_{k,1,5},E_{k,1,9},E_{k,1,13})−min(E_{k,1,2},E_{k,1,6},E_{k,1,10},E_{k,1,14},E_{k,1,3},E_{k,1,1,7},E_{k,1,11},E_{E}_{k,1,15})

ρₖ³=min(E_{k,1,0}E_{k,1,4},E_{k,1,8},E_{k,1,12},E_{k,1,2},E_{k,1,6},E_{k,1,10},E_{k,1,14})−min(E_{k,1,1},E_{k,1,5},E_{k,1,9},E_{k,1,13},E_{k,1,3},E_{k,1,7},E_{k,1,11},E_{k,1,15}) Eq, 11

In Eq. 11, k denotes a symbol number, and k is 8 and 7 (k=7, k=8).

FIG. 7 is a block diagram illustrating a symbol hard-decision and symbol distance calculator in accordance with an embodiment of the present invention. That is, FIG. 7 shows a symbol hard decision and symbol distance calculator for a 4^{th} cycle.

In the present embodiment, the multiplication is performed using a bit shifter and an adder instead of using a calculator having a complicated computation structure. That is, a shift and adder 701 performs a shift and add operation on a 5^{th} column of an R matrix as much as symbols generated according to a symbol generation scheme of Eq. 12. For example, since ⅞ which is a symbol candidate group of 64 QAM is ‘ 4/8+ 2/8+⅛’, the shift and adder can be used to obtain a multiplying operation instead of a calculator such as a multiplier.

$${y}_{i} = C * {y}_{i} , \\ where C = \{ \begin{matrix}Q4\_POW2 = \frac{0.5}{1 / \sqrt{2}} , & for QPSK \\ Q16\_POW2 = \frac{0.5}{2 / \sqrt{10}} , & for 16 QAM \\ Q64\_POW2 = \frac{0.5}{4 / \sqrt{42}} , & for 64 QAM\end{matrix} \\ {s}_{i} = \{ \begin{matrix}( - \frac{1}{2} , \frac{1}{2} ) + j ( - \frac{1}{2} , \frac{1}{2} ) , & for QPSK \\ ( - \frac{3}{4} , - \frac{1}{4} , \frac{1}{4} , - \frac{3}{4} ) + j ( - \frac{3}{4} , - \frac{1}{4} , \frac{1}{4} , \frac{3}{4} ) , & for 16 QAM \\ \begin{matrix}( - \frac{7}{8} , - \frac{5}{8} , - \frac{3}{8} , - \frac{1}{8} , \frac{7}{8} , \frac{5}{8} , \frac{3}{8} , \frac{1}{8} ) + \\ j ( - \frac{7}{8} , - \frac{5}{8} , - \frac{3}{8} , - \frac{1}{8} , \frac{7}{8} , \frac{5}{8} , \frac{3}{8} , \frac{1}{8} ) ,\end{matrix} & for 64 QAM\end{matrix} \\ \begin{matrix}{y}_{i} = {y}_{i} - {r}_{k , i} * {s}_{i} \\ = {y}_{i} - {r}_{k , i} * \{ \begin{matrix}( - \frac{1}{2} , \frac{1}{2} ) + j ( - \frac{1}{2} , \frac{1}{2} ) , & for QPSK \\ ( - \frac{3}{4} , - \frac{1}{4} , \frac{1}{4} , - \frac{3}{4} ) + j ( - \frac{3}{4} , - \frac{1}{4} , \frac{1}{4} , \frac{3}{4} ) , & for 16 QAM \\ \begin{matrix}( - \frac{7}{8} , - \frac{5}{8} , - \frac{3}{8} , - \frac{1}{8} , \frac{7}{8} , \frac{5}{8} , \frac{3}{8} , \frac{1}{8} ) + \\ j ( - \frac{7}{8} , - \frac{5}{8} , - \frac{3}{8} , - \frac{1}{8} , \frac{7}{8} , \frac{5}{8} , \frac{3}{8} , \frac{1}{8} ) ,\end{matrix} & for 64 QAM\end{matrix}\end{matrix} \qquad Eq . 12$$

Referring to FIG. 7, the shift and adder 701 shifts columns of an inputted R matrix as much as symbols generated from the symbol generator and adds. Then, a multiplexer 703 selects one of the outputs of the shift and adder 701 based on a hard decision symbol of a previous cycle, which is selected by a multiplexer 702. Then, a subtractor 705 outputs a newly updated receiving signal y by subtracting the selected value from the multiplexer 703 from the updated receiving signal y of the previous cycle, which is selected by the multiplexer 704. The updated receiving signal outputted from the subtractor 705 is squared and accumulated with a distance value of a 6^{th} symbol, thereby calculating a distance value of a 5^{th} symbol. Meanwhile, a hard decision unit 708 performs a hard decision operation for a 4^{th} symbol.

As described above, a hardware structure of an MIMO receiver can become simple because a shifter and an adder are used for detecting a 8^{th} symbol and a 7^{th} symbol instead of using a complicated calculator such as a multiplier.

The present application contains subject matter related to Korean Patent Application No. 2007-0132492, filed in the Korean Intellectual Property Office on Dec. 17, 2007, the entire contents of which is incorporated herein by reference.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. A receiver of a Multiple Input Multiple Output (MIMO) system, comprising:
a QR decomposing means for performing a QR decomposing operation in cycles 1 to n_{T}-n−1, and performing a column exchanging operation in cycles n_{T}-n to n_{T} as QR decomposition where n and T are an integer number, where n_{T} denotes the number of transmission antennas; and
a multi-dimensional detecting means for receiving a first R matrix R_{y} and a second R matrix R_{z} from the QR decomposing means, calculating a first distance value for detecting an m^{th} symbol for the first R matrix and a second distance value for detecting an m^{th} symbol for the second R matrix, and simultaneously detecting an m^{th} symbol and an (m−1)^{th} symbol using the first distance value and the second distance value.

2. The receiver of claim 1, wherein the QR decomposing means includes:
a norm calculating means for calculating a vector size norm for a channel input;
a Q column calculating means for calculating a column value of a unitary matrix Q using the channel input and \sqrt{norm};
an R row calculating means for calculating a row value of an upper triangular matrix R by receiving the channel input, the output of the Q column calculating means, and the 1/\sqrt{norm};
a Q update calculating means for receiving the channel input, the output of the R column calculating means, and the output of the Q row calculating means, and outputting a Q update matrix value;
a norm update calculating means for receiving the output of the norm calculating means and the output of the R row calculating means and outputs a norm update matrix value; and
a column exchanging means for column-exchanging a norm value, a Q column value, and an R row value in cycles n_{T}-n to n_{T} where n and T are a natural number,
wherein the Q column calculating means, the R row calculating means, the Q update calculating means, and the norm update calculating means perform calculation based on the column-exchanged norm value, the column-exchanged Q column value, and the column-exchanged R row value.

3. The receiver of claim 2, wherein the multi-dimensional detecting means includes:
a symbol generating means for generating a symbol having a lattice point;
a plurality of symbol distance calculating means for receiving the first and second R matrices, and the generated symbol, performing hard decision to decide a next symbol for the first and second R matrices, calculating symbol distance values for detecting an m^{th} symbol for the first and second R matrices, and outputting updated receiving signal y values for the first and second R matrices;
a register for temporally storing the updated receiving signal y values;
an accumulating buffer for accumulating and storing t symbol distance values for the first and second R matrices, which are calculated by the plurality of symbol distance calculating means; and
a symbol deciding means for receiving the distance values for detecting an m^{th} symbol for the first R matrix and distance values for detecting an m^{th} symbol for the second R matrix from the accumulating buffer and deciding an m^{th} symbol and an (m−1)^{th} symbol at the same time.

4. A QR decomposition apparatus used in a receiver of a Multiple Input Multiple Output (MIMO) system, comprising:
a norm calculating means for calculating a vector size norm for a channel input;
a Q column calculating means for calculating a column value of an unitary matrix Q using the channel input and \sqrt{norm};
an R row calculating means for calculating a row value of an upper triangular matrix R by receiving the channel input, the output of the Q column calculating means, and the 1/\sqrt{norm};
a Q update calculating means for receiving the channel input, the output of the R column calculating means, and the output of the Q row calculating means, and outputting a Q update matrix value;
a norm update calculating means for receiving the output of the norm calculating means and the output of the R row calculating means and outputs a norm update matrix value; and
a column exchanging means for column-exchanging a norm value, a Q column value, and a R row value in cycles n_{T}-n to n_{T} where n and T are a natural number,
wherein the Q column calculating means, the R row calculating means, the Q update calculating means, and the norm update calculating means perform calculation using the column-exchanged norm value, the column-exchanged Q column value, and the column-exchanged R row value.

5. The QR decomposition apparatus of claim 4, further comprising:
a first memory means for receiving the output of the norm calculating means and outputting the value \sqrt{norm} using a lookup table; and
a second memory means for receiving the output of the norm calculating means and outputting the value 1/\sqrt{norm} using a lookup table.

6. The QR decomposition apparatus of claim 5, further comprising:
a first delay means for delaying the channel input and outputting the delayed channel input;
a second delay means for delaying the output of the norm calculating means and outputting the delayed output; and
a third delay means for delaying the output of the Q column calculating means and outputting the delayed output.

7. The QR decomposition apparatus of claim 4, wherein last n columns of a first Q matrix Q_{y} and a second Q matrix Q_{z}, which are calculated by the Q column calculating means through column exchanging, are different, and columns are exchanged until a predetermined number row of last columns and remaining row values of last n columns have different values in a first R matrix R_{y} and a second R matrix R_{z}, which are calculated by the R row calculating means through column exchanging.

8. A QR decomposition method in a receiver of a Multiple Input Multiple Output (MIMO) system, comprising the steps of:
calculating a vector size norm for a channel input;
calculating a column value of an unitary matrix Q using the channel input and \sqrt{norm};
calculating a row value of an upper triangular matrix R by receiving the channel input, the Q column value, and the 1/\sqrt{norm};
calculating a Q update matrix value using the channel input, the R column value, and the Q row value;
calculating a norm update matrix value using the norm value and the R matrix value; and
column-exchanging a norm value, a Q column value, and a R row value in cycles n_{T}-n to n_{T} where n and T are a natural number, and performing additional QR calculation using the column-exchanged norm value, the column-exchanged Q column value, and the column-exchanged R row value.

9. The QR decomposition method of claim 8, wherein the value \sqrt{norm} and the value 1/\sqrt{norm} are calculated using a lookup table.

10. The QR decomposition method of claim 8, wherein last n columns of a first Q matrix Q_{y} and a second Q matrix Q_{z}, which are calculated in the step f) through column exchanging, are different, and columns are exchanged until a predetermined number row of last columns and remaining row values of last n columns have different values in a first R matrix R_{y} and a second R matrix R_{z}, which are calculated through column exchanging.

11. A multi-dimensional detecting apparatus used in a receiver of a Multiple Input Multiple Output (MIMO) system, comprising:
a symbol detecting means for receiving a first R matrix R_{y} and a second R matrix R_{z} from a QR decomposing apparatus as a QR decomposition result of cycles 1 to n_{T}-n−1 and a QR decomposition result additionally calculated through column exchanging, calculating a first distance value for detecting an m^{th} symbol for the first R matrix and a second distance value for detecting an m^{th} symbol for the second R matrix, and simultaneously detecting an m^{th} symbol and an (m−1)^{th} symbol using the first distance value and the second distance value.

12. The multi-dimensional detecting apparatus of claim 11, in the first R matrix R_{y} and the second R matrix R_{z}, columns are exchanged to a predetermined number row of last n columns, and remaining rows of the last n columns have different values.

13. The multi-dimensional detecting apparatus of claim 11, wherein the symbol detecting means includes:
a symbol generating means for generating a symbol having a lattice point;
a plurality of symbol distance calculating means for receiving the first and second R matrices, and the generated symbol, performing hard decision to decide a next symbol for the first and second R matrices, calculating symbol distance values for detecting an m^{th} symbol for the first and second R matrices, and outputting updated receiving signal y values for the first and second R matrices;
a register for temporally storing the updated receiving signal y values;
an accumulating buffer for accumulating and storing t symbol distance values for the first and second R matrices, which are calculated by the plurality of symbol distance calculating means; and
a symbol deciding means for receiving the distance values for detecting an m^{th} symbol for the first R matrix and distance values for detecting an m^{th} symbol for the second R matrix from the accumulating buffer and deciding an m^{th} symbol and an (m−1)^{th} symbol at the same time.

14. The multi-dimensional detecting apparatus of claim 13, wherein each of the plurality of symbol distance calculating means includes:
a first hard decision and symbol distance calculating means for receiving the first R matrix, the second R matrix, and the generated symbol, performing hard decision for an (m−1)^{th} symbol for the first and second R matrices, calculating a distance value of an m^{th} symbol for each of the first and second R matrices, and outputting an updated receiving signal y value for the first and second R matrices;
a second hard decision and symbol distance calculating means for receiving the first R matrix, the second R matrix, the generated symbol, a receiving signal value updated at a previous cycle, and a hard decision result of a previous cycle, performing hard decision for an (m−2)^{th} symbol for the first and second R matrices, calculating a distance value of an (m−1)^{th} symbol for each of the first and second R matrices, and outputting an updated receiving signal y value for the first and second R matrices; and
a plurality of third hard decision and symbol distance calculating means for receiving the first R matrix, the generated symbol, a receiving signal value updated at a previous cycle, and a hard decision result of a previous cycle, performing hard decision for a next symbol for the first and second R matrices, calculating an own symbol distance value for each of the first and second R matrices, and outputting an updated receiving signal y value for each of the first and second R matrices.

15. The multi-dimensional detecting apparatus of claim 14, wherein each of the plurality of third hard decision and symbol distance calculating means includes:
a plurality of shift and add means for shifting and adding an inputted R matrix as much as symbols generated by the symbol generating means;
a calculating means for calculating a distance value for symbol detection using the shifting and adding result, a previous hard decision result, and an updated receiving signal y; and
a hard decision means for performing hard decision for a newly updated receiving signal y based on a result of the shift and add means.

16. The multi-dimensional detecting apparatus of claim 15, wherein the calculating means calculates a distance value for own symbol by subtracting a column value of a R matrix of the shift and add means, which is selected by a previous hard decision result from the updated receiving signal y, and accumulating the subtracting result and a previous symbol distance value.

17. A multi-dimensional detecting method used in a receiver of a Multiple Input Multiple Output (MIMO) system, comprising the steps of:
a) generating symbols;
b) receiving a first R matrix R_{y} and a second R matrix R_{z} from a QR decomposing apparatus as a QR decomposition result of cycles 1 to n_{T}-n−1 and a QR decomposition result additionally calculated through column exchanging, receiving the generated symbols, calculating a first distance value for detecting an m^{th} symbol for the first R matrix and a second distance value for detecting an m^{th} symbol for the second R matrix; and
c) simultaneously detecting an m^{th} symbol and an (m−1)^{th} symbol using the first distance value and the second distance value.

18. The multi-dimensional detecting method of claim 17, in the first R matrix R_{y} and the second R matrix R_{z}, columns are exchanged to a predetermined number row of a last n column, and remaining rows of the last n column have different values.

19. The multi-dimensional detecting method of claim 17, wherein the step b) includes the steps of:
performing hard decision for an (m−1)^{th} symbol for each of the first and second R matrices, calculating a distance value of an m^{th} symbol for each of the first and second R matrices, and outputting an updated receiving signal y value for each of the first and second R matrices;
performing hard decision for an (m−₂)^{th} symbol for each of the first and second R matrices, calculating a distance value of an (m−1)^{th} symbol for each of the first and second R matrices, and outputting an updated receiving signal y value for each of the first and second R matrices; and
performing hard decision for a next symbol for each of the first and second R matrices, calculating a distance value of an own symbol for each of the first and second R matrices, and outputting an updated receiving signal y value for each of the first and second R matrices.

20. The multi-dimensional detecting method of claim 19, wherein a distance value of an m^{th} symbol for the first R matrix is calculated by calculating a first value through multiplying a constant C and an m^{th} receiving signal vector, calculating a second value through multiplying of an m^{th} element of the first R matrix and an m^{th} element of the generated symbol, subtracting the first value from the second value, and squaring an absolute value of the subtracting result.

21. The multi-dimensional detecting method of claim 19, wherein a distance value of an m^{th} symbol for the second R matrix is calculated by multiplying an m^{th} element of the second R matrix and an (m−1)^{th} element of the generated symbol, subtracting the multiplying result from an m^{th} receiving signal vector, and squaring an absolute value of the subtracting result.

22. The multi-dimensional detecting method of claim 19, wherein a distance value of an (m−1)^{th} symbol for the first R matrix is calculated by multiplying an (m−1)^{th} element of the first R matrix and a hard decision element of an (m−1)^{th} symbol for the first R matrix, subtracting the multiplying result from a updated (m−1)^{th} receiving signal for the first R matrix, squaring an absolute value of the subtracting result, and accumulating the squaring result and a distance value of an m^{th} symbol for the first R matrix.

23. The multi-dimensional detecting means of claim 19, wherein a distance value of an (m−1)^{th} symbol for the second R matrix is calculated by multiplying an (m−1)^{th} element of the second R matrix and a hard decision element of an (m−1)^{th} symbol for the second R matrix, subtracting the multiplying result from a updated (m−1) th receiving signal for the second R matrix, squaring an absolute value of the subtracting result, and accumulating the squaring result and a distance value of an m^{th} symbol for the second R matrix.

24. The multi-dimensional detecting means of claim 20, wherein the multiplying result of an m^{th} element of the first R matrix and an m^{th} element of the generated symbol is calculated by shifting the first R matrix value as much as the generated symbols and adding.
